(19) United States
(12) Patent Application Publication
(10) Pub. No.: US 2009/0180852 A1
(43) Pub. Date: Jul. 16, 2009

(54) Dumping Tub and Attachment

(76) Inventors: Mark Edwin Schlofman, North Salt Lake, UT (US); Sean Chritopher Haymond, Columbia, SC (US); Gregory Richard Rosendabl, Provo, UT (US); Benjamin Lewis Nelson, Corvallis, OR (US); Fred P. Smith, Alpine, UT (US)

Correspondence Address: Floris Chad Copier, 5373 W. 10480 N., Highland, UT, 84003, US

(21) Appl. No.: 12/248,018

(22) Filed: Oct. 8, 2008

Related U.S. Application Data
(60) Provisional application No. 61/010,782, filed on Jan. 12, 2008.

(51) Int. Cl. B65G 65/34

(52) U.S. Cl. 414/425; 414/809

(57) ABSTRACT

A dumping tub and attachment may include a tub, mounting structure and caster wheel assembly. The mounting structure may be connected to the standard bucket of a utility loader. The mounting structure may be pivotally connected to the rear and bottom of the tub along a lateral axis. The caster wheel assembly may be connected to the front of the tub.

### PRIORITY

This invention claims priority to U.S. Provisional Patent Application No. 61/010,782 filed Jan. 12, 2008, which is incorporated herein in its entirety.

### FIELD

This application describes devices related to an attachment for a utility loader, compact loader, skid steer or similar vehicle. More specifically, this application describes embodiments related to an attachment used to increase the carrying capacity of the utility loader.

### BACKGROUND

Due to their versatility, utility loaders are used at many different kinds of job sites including construction, landscaping and utility work. Utility loaders, such as compact loaders, skid steer loaders or other similar vehicles, may be wheeled or tracked or even have tracks that go over the wheels. These utility loaders have many different possible attachments. One of the most common attachments is a bucket used for carrying soil, rocks, gravel etc. Frequently, these materials must be moved to different locations at the job site. The bucket attachment to the utility loader has a limited capacity, requiring the operator to make several trips, consuming a lot of time. One of the reasons capacity is limited is that only a certain load can be carried in the bucket without capsizing the utility loader. The larger the bucket the more the weight overhangs the front wheel or front of the track further increasing the probability of capsizing the utility loader.

A solution to this problem is a hopper or tub attachment that is supported partially by the utility loader and partially by the ground on its own wheels. This tub attachment may have a much larger capacity than the standard bucket allowing the operator to move more material on each trip and still be able to dump it. Examples of this type of tub attachment can be seen in U.S. Pat. Nos. 5,618,155, 5,921,743 6,889,877.

The tub attachments of the prior art have deficiencies that cause them to be difficult to use. The attachment shown in U.S. Pat. No. 5,618,155 shows a method of connecting the bucket of the utility loader to a trailer with a hook that raises the trailer up into the dumping position (FIG. 7). This type of attachment must articulate at the hook, like a truck and trailer. Maneuvering the hopper is difficult as anyone who has backed a trailer knows. This attachment also requires making modifications to the utility loader bucket.

U.S. Pat. No. 5,921,743 overcomes the difficulty of maneuvering the hopper by utilizing two casters on the front of the hopper and an attachment to the utility loader that is rigid about a vertical axis. Dumping is accomplished by two cylinders that pivot the tub on it supporting framework. This requires extra expense of additional cylinders, auxiliary valves and hydraulics on the utility loader. Additionally, dumping the tub with a hydraulic cylinder between the tub and its framework adds to the time required to attach the tub attachment to the utility loader, increases the weight and manufacturing costs of the tub attachment and increases the maintenance needed for the tub attachment.

U.S. Pat. No. 6,889,877 is known in the industry as the Bobcat dumping hopper attachment. This hopper rigidly connects to the attachment plate of the lift arms of the utility loader. Because the attachment is rigid around a transverse axis, there is difficulty when going over hills or through dips as the angle of the attachment plate must be manually adjusted in order to keep all the wheels on the ground. The same difficulty applies when dumping the hopper. The attachment plate must be manually adjusted to the angle of the back of the hopper as it is being dumped. This prior art also requires removal of the standard bucket without providing storage for the bucket. If only one utility loader is present, loading and transporting the tub attachment requires the operator to remove and reattach the standard bucket several times if the loader is also being used to load the larger tub or hopper.

For example, the utility loader may be unloaded from a trailer in the street, the standard bucket dropped and the large hopper connected and driven to the rear of a building. In order to then load the large hopper the operator may then have to drive the utility loader to the street to retrieve the standard bucket, and again drive to the rear of the building. At the end of loading the large hopper, the standard bucket is driven to the street and the operator again goes back to the rear of the building to connect to the large hopper, then driving it to the street. This requires a lot of time.

Another difficulty with auxiliary hopper attachments is the lack of room for such auxiliary hoppers on the vehicle that the operator uses to transport the utility loader to a jobsite. Many times there is a lack of room on the trailer or other vehicle for additional attachments, especially an attachment the size of an auxiliary tub.

Some problems with conventional dumping tubs include when the tub is lifted too high, the front of the tub might contact the ground. When a single-wheeled caster wheel assembly (or two single-wheeled caster assemblies) comes off the ground, the caster wheel will usually fall on its side and the tub will not then ride on the wheel. When this happens, lowering the tub is very difficult because the tub is now not rolling on the ground. Therefore, to lower the tub requires that the utility loader is moved backward at the same time the dumping tub is being lowered. Further, standard single caster wheels may become unstable during dumping. If the caster wheel is turned somewhat during the dumping process, the force of the ground on the wheel produces a moment about the caster rotation axis which causes the caster to capsize, pushing the tub sideways. This can be quite disconcerting when dumping in close quarters.

A further difficulty is transporting multiple tubs from the point of manufacture to the point of sale or distribution. The tubs are relatively large in volume and transporting them, for instance by trailer, one would easily run out of room on the trailer before the weight limit for the trailer was reached.

### SUMMARY

One embodiment of a dumping tub and attachment may include a tub, mounting structure and caster wheel assembly. The mounting structure may be connected to the standard bucket of a utility loader. The mounting structure may be pivotally connected to the rear and bottom of the tub along a lateral axis. The caster wheel assembly may be connected to the front of the tub.

The tub may consist of 4 walls and a floor. These walls may be made of flat metal sheets or they may be curved or corrugated as would be understood by one of skill in the art. The back wall may be pivotally connected to the rest of the tub at or near the floor such that the rear wall can fold down and function as a ramp, allowing the utility loader to be driven into the tub. The caster wheel assembly may be mounted to a bracket that can be easily removed from the tub for transport or storage.

In some embodiments, the tub may employ the use of single-wheeled or twin-wheeled caster wheel assembly. When a single-wheeled caster wheel assembly is used, the caster wheel assembly may be designed with more trail, circumference, and/or width than is used normally on a caster wheel for this type of application.

In some embodiments the utility loader arms or utility loader attachment mounting plate may be directly attached to the tub instead of the end of the bucket. In such embodiments, a larger load may be carried and dumped from the dumping tub as the proportionate load that the utility loader must carry is applied closer to the front wheels or front of the track, reducing the overturning moment. Attaching the dumping tub to the arms or attachment mounting plate of the utility loader requires removal of the bucket. An attachment point may be provided on the tub to allow attachment or storage of the bucket on the dumping tub while the tub is being transported from one location to another, thus allowing for easy reattachment of the bucket at each location of the tub.

Advantages of the embodiments described may include providing a bucket interface on the dumping tub to save the operator from having to frequently remove and reattach the bucket. In another embodiment, temporarily mounting and carrying the bucket on the dumping tub when the tub is connected directly to the mounting plate of the utility loader may save substantial travel time of the utility loader, reducing the transit time for the utility loader.

The pivot between the mounting structure and the tub may cause a portion of the weight of the tub and load in the tub to be held by the utility loader and a portion to be supported by the caster wheel without transmitting any moments to the utility loader. This pivot prevents potentially damaging moment loads from being transferred between the utility loader and the dumping tub.

Placing the pivot at the bottom of the dumping tub and at the front-most portion of the bucket maximizes the size of the tub that can be fully dumped. This is because the front-most portion of the bucket can be raised significantly higher than other portions of the bucket or the utility loader's arms. Thus, for small utility loaders, a relatively long dumping tub can still be dumped at a high enough angle to remove material from the dumping tub. Placing the pivot higher on the tub would restrict the possible angles of relative rotation between the tub and the bucket.

Storage space is often a significant concern. This is particularly true on the trailers used to transfer the equipment to and from the job site. Driving the utility loader into the dumping tub may greatly reduce the space needed to store both items, as the utility loader may be placed into the dumping tub during transport.

Making the caster wheel assembly removable and sloping the sides of the tub inward towards the bottom of the tub may allows multiple dumping tubs to be stacked into each other. This will cut down on the space needed to store them which will reduce shipping costs.

In some embodiments, a double-wheeled caster wheel may be positioned such that as the tub is dumped it rides on the caster all the way from the down position to the dumped position and the double wheels keep the caster from capsizing. Likewise, in other embodiments utilizing a single wheel caster, increasing the trail distance of the caster wheel assembly removes the possibility of the ground force causing a moment about the caster axis that would cause it to capsize. Indeed if a single-wheeled caster wheel assembly with sufficiently increased trail distance is raised off the ground during dumping such that it falls over, it will actually right itself when the wheel comes back into contact with the ground. This simplifies the dumping operation when a single-wheeled caster wheel assembly is employed.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is an isometric view of an embodiment of a dumping tub in a loading position;

FIG. 2 is a side view of an embodiment of a dumping tub;

FIG. 3 is a side view of an embodiment of a dumping tub in an unloading position;

FIG. 4 is a side view of an embodiment of a bucket attachment;

FIG. 5a is a back view of an embodiment of a dumping tub;

FIG. 5b is an isometric view of an embodiment of a bucket attachment;

FIG. 6 is a side view of a utility loader positioned in an embodiment of a dumping tub;

FIG. 7 is a detailed view of an embodiment of a door locking device;

FIG. 8 is an isometric view of an embodiment of dumping tubs prepared for transport;

FIG. 9 is a side view of the wheel assembly connected to the dumping tub;

FIG. 10 is an isometric view of an embodiment of a dumping tub connection to an utility loader;

FIG. 11 is an isometric view of an embodiment of a dumping tub with bucket storage;

FIG. 12 is a side view of an embodiment of a dumping tub with a view of an utility loader connector;

FIG. 13 is an isometric view of an embodiment of a dumping tub with an utility loader connection.

### DETAILED DESCRIPTION

As in the illustrated embodiments, aspects and features of dumping tubs and associated methods are disclosed and described below. The following description supplies specific details in order to provide a thorough understanding. Nevertheless, the skilled artisan would understand that the apparatus and associated methods of using the apparatus can be implemented and used without employing these specific details. Indeed, the devices and associated methods can be placed into practice by modifying the illustrated devices and associated methods and can be used in conjunction with any other apparatus and techniques conventionally used in the industry. For example, while this description focuses on dumping tubs for use with a utility loader, embodiments employing the principles described herein may be used on or with backhoes, loaders, atvs, yard tractors, farm tractors, etc. without departing from the scope of the embodiments described herein.

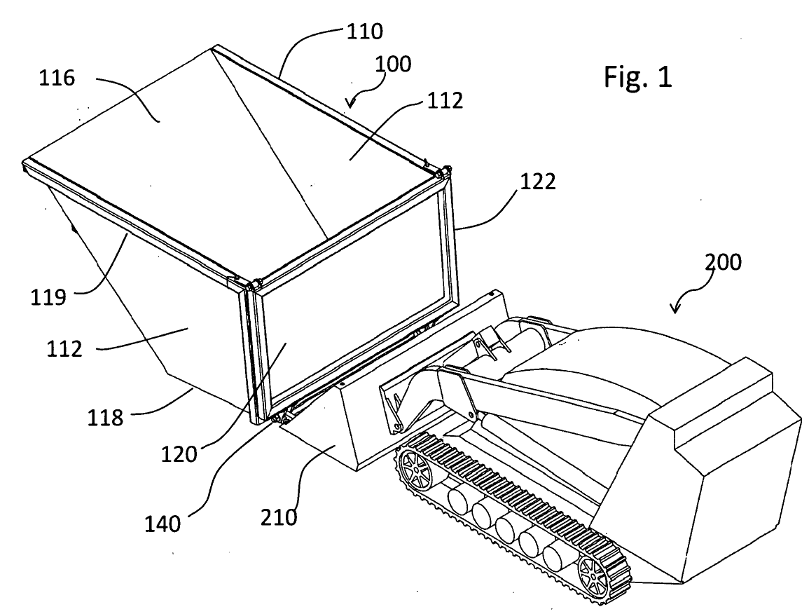

FIG. 1, illustrates dumping tub 100 connected to utility loader 200. Dumping tub 100 may include tub body 110, rear door 120, mounting structure 140 and wheel assembly 160. Tub body 110 may include sidewalls 112, sloping front wall 116, floor 112 and rear door 120. Utility loader 200 may be of any type that includes a bucket 210 or interchangeable connector (not shown), but will discussed as if it were a simlar size and shape to the utility loader 200 shown for the purpose of describing certain aspects of this embodiment.

Various material may be contained in the dumping tub 100 by side walls 112, sloped front wall 116, floor 118 and rear door 120. The walls may have additional supporting structure such as tubing 119 in various geometries. This is particularly important at the top of the walls to keep them from bowing out when dumping tub 100 is filled with material. Rear door 120 may also have tubing 122 around its periphery.

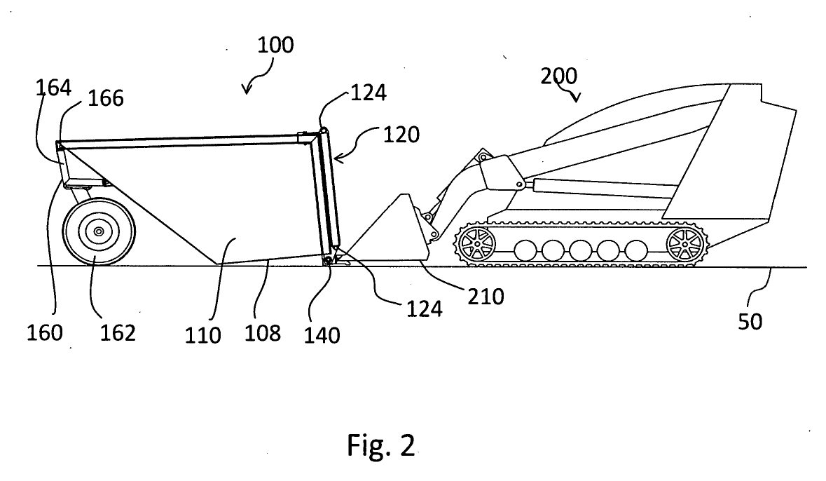

FIG. 2 illustrates dumping tub 100 in the loading position. Utility loader 200 may engage dumping tub 100 by bucket 210 engaging mounting structure 140. When loading, bucket 210 may be lowered such that it remains at or near ground 50. In this position, dumping tub 100 rests on wheel assembly 160, tub body 110 and/or bucket 210. Similarly, when dumping tub 100 is full of material, bucket 210 may be moved slightly above ground 50 such that tub body 110 pivots upward through mounting structure 140 and only wheel assembly 160 and utility loader 200 make contact with the ground 50. This configuration has the advantage of pivoting mounting structure 140 that allows dumping tub 100 and utility loader 200 to independently adjust to uneven ground (not shown).

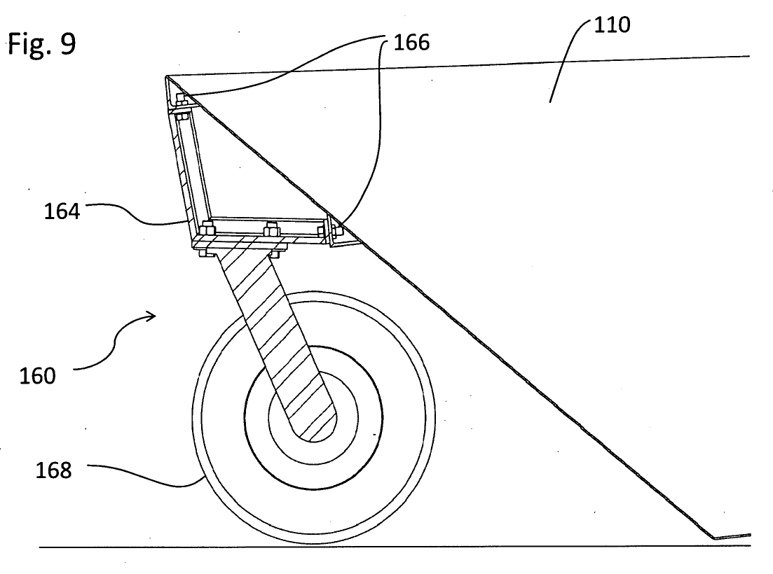

Wheel assembly 160 (further described with respect to FIG. 9) may be positioned such that in the lowered position, floor 118 may be either just touching the ground 50 or may be slightly off of the ground 50. When in transit, wheel assembly 160 may be configured to freely move, such that when the utility loader is turned, the wheel assembly 160 allows the dumping tub 100 to move in a sideways direction. For example, wheel assembly 160 may function as a caster.

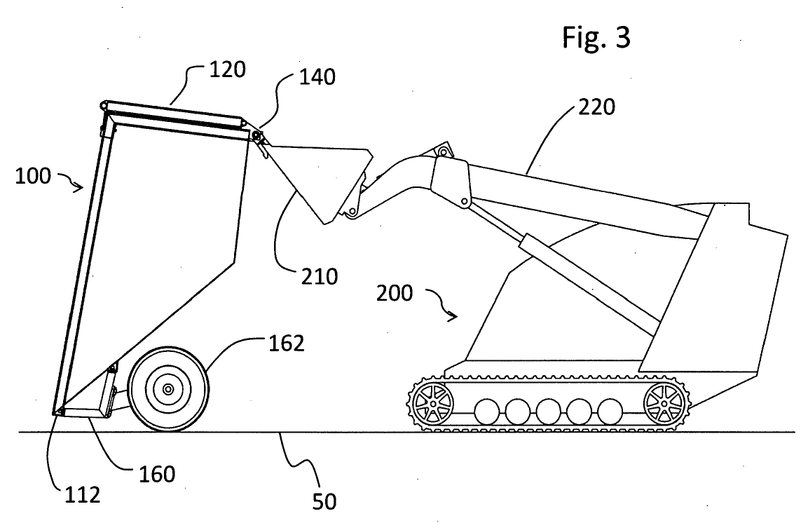

Turning to FIG. 3, dumping tub 100 is shown in a dumping position. The placement of mounting structure 140 near the bottom of dumping tub 100 allows utility loader 200 to fully rotate dumping tub 100 upright, when compared with a similar attachment at the top. For example, mounting structure 140 pivoting at or near the bottom surface of dumping tub 100 allows use of the entire lifting range of utility loader 200.

As utility loader 200 raises boom 220, mounting structure 140 may pivot such that floor 118 may be at an angle of forty-five degrees to ground 50 or greater. Similarly, sloping front wall 116 may also be at an angle of forty-five degrees to ground 50 or greater. This angle is well known in the art to be sufficient to have most materials slide off of a metal surface.

Wheel assembly 160 may be also positioned such that it remains in contact with the ground 50 while the dumping tub front edge just touches the ground or is off of the ground when the sloping front wall 116 of the dumping tub 100 is at an angle of 45 degrees to the ground or greater. By remaining in contact with the ground 50, caster wheel 162, of wheel assembly 160, may be prevented from capsizing.

Caster wheel 162 may be a single wheeled caster wheel, twin caster wheel or multiple caster wheels. When a single-wheeled caster wheel assembly 160 is used, caster wheel assembly 160 may be designed with more trail, caster angle, circumference, and/or width than is used normally on a caster wheel for this type of application. A twin caster wheel may be similarly modified and adds the extra benefit of resistance to capsizing due to the two wheels providing opposing forces on the axle, preventing capsizing. Multiple caster wheels may use any of the benefits above and provide further stability of the dumping tub 100 by distributing weight among multiple caster wheels 162.

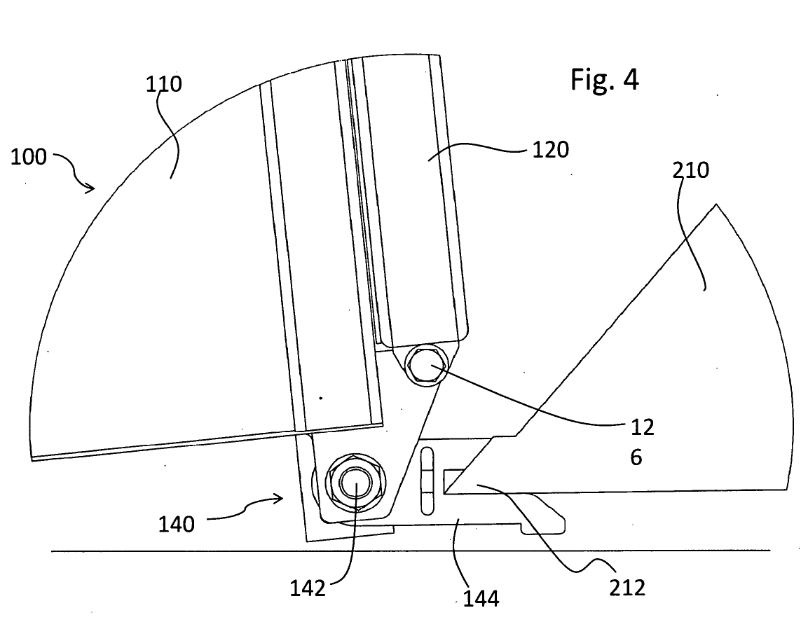

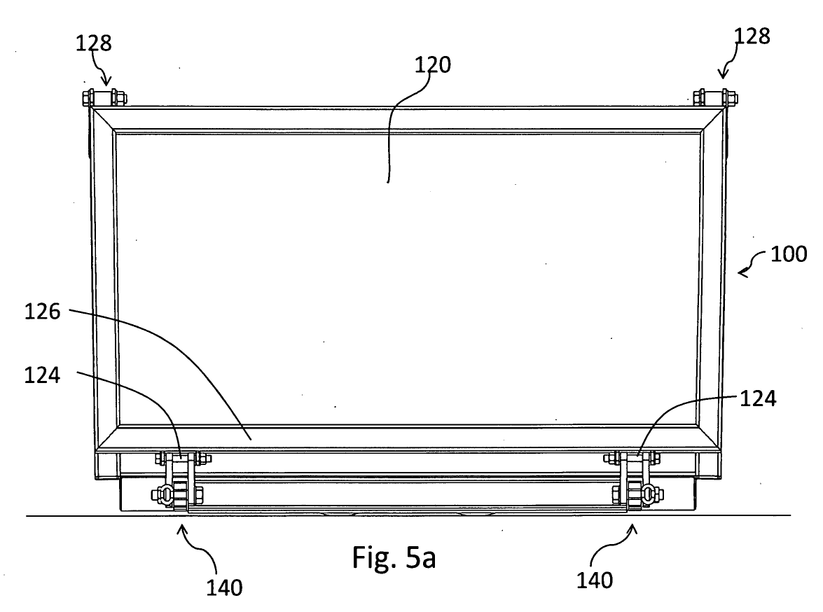

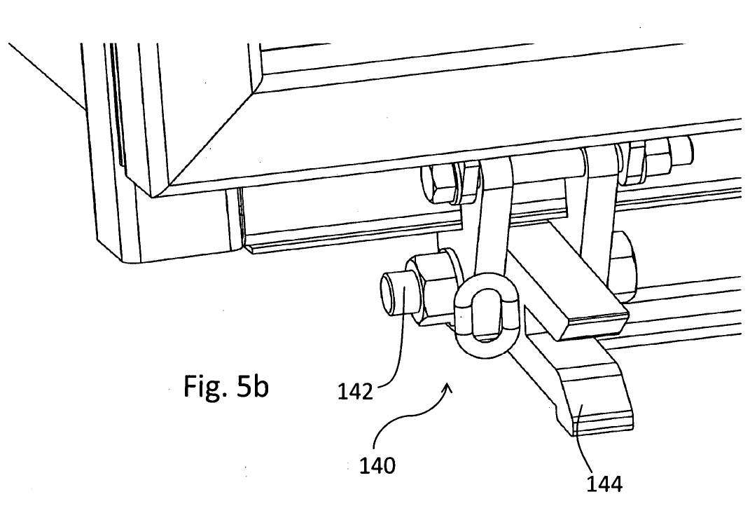

FIGS. 4-5b illustrate rear door pivot 124 and mounting structure 140, which allows for connection of dumping tub 100 to bucket 210 of utility loader 200. Mounting structure 140 may include mounting pivot 142 and bucket attaching device 144. Mounting structure 140 may be held to lower lip 212 of bucket 210 with chains or other suitable means.

Bucket attaching device 144 may be pivotally connected to the tub body 110 by pivot connector 142. Pivot connector 142 may allow tub body 110 to pivot with respect to bucket attaching device 144, bucket 210, utility loader boom 220, and utility loader 200. By pivoting, bucket attaching device 144 prevents a moment from forming at the connection between dumping tub 100 and utility loader 200.

Rear door 120, pivots about the rear door pivot 124. Rear door beam 126 may extend across the bottom of the dumping tub near the rear door 120 providing reinforcement. Rear door pivot 124 allows the rear door 120 to pivot downward and for a ramp and entrance to the dumping tub 100. In some embodiments, rear door 120 may be a rear wall that does not open, similar to sidewalls 112.

One advantage of this embodiment may be that bucket 210 remains on the utility loader 200. Typically a user of dumping tub 100 must disconnect the bucket 210, attach dumping tub 100, drive tub 100 to a desired spot, return for bucket 210, reattach bucket 210, drive back to dumping tub 100 and begin work. The return trip is similar, requiring multiple trips and connections. Here, bucket 210 remains on the utility loader 200, and dumping tub 100 may be moved to any spot where work can immediately commence.

FIG. 5a illustrates rear door 120 in a locked position ready for loading. Rear door 120 may be connected to dumping tub 100 by rear door locking devices 130 and rear door pivot 124. When rear door locking devices 130 are disengaged, rear door 120 may be permitted to rotate downward to form a ramp and entrance to dumping tub 100 in preparation for transport.

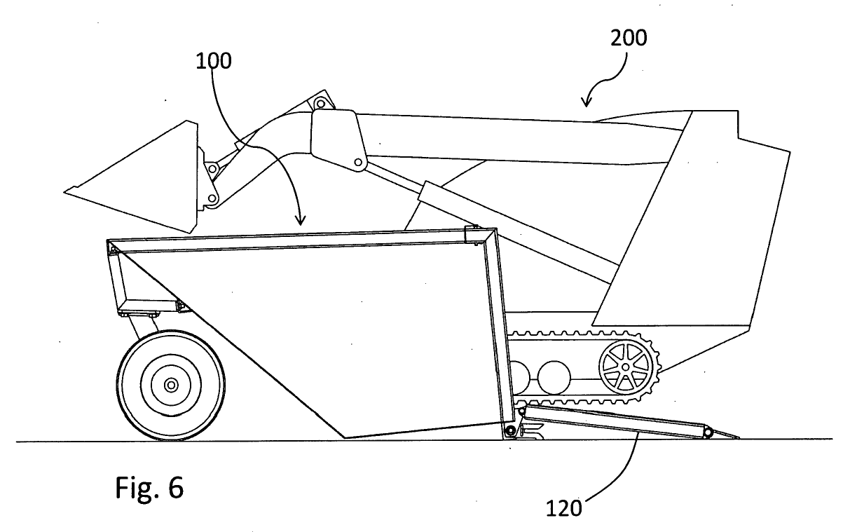

FIG. 6 illustrates dumping tub 100 and utility loader 200 prepared for transport. As illustrated, rear door 120 may be in a lowered position from dumping tub 100 providing a ramp. Utility loader 200 may then enter dumping tub 100. Once together, dumping tub 100 and utility loader 200 may be tied down in preparation for transport. This placement may provide for a more compact and efficient transport of dumping tub 100 and utility loader 200, allowing for transport of both utility loader 200 and dumping tub 100 in a relatively small space, such as on a trailer.

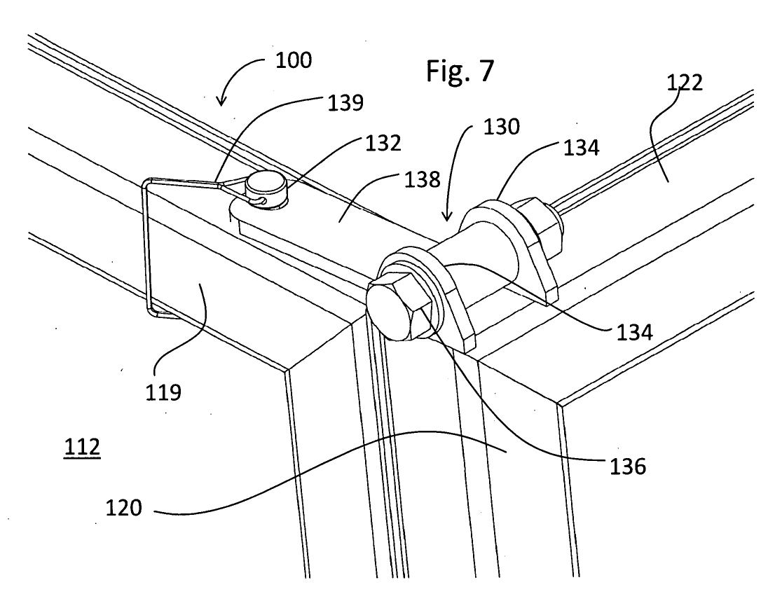

FIG. 7 illustrates rear door locking device 130 connecting rear door 120 and tub body 110. Rear door locking device 130 may be mounted on the top of the rear door 120 on tubing 122 and side wall 112 supporting tubing 119. This configuration may direct the majority of force as shear force on a retaining pin 132, which may be preferable to a pin locking mechanism.

Rear door locking device 130 may provide a structure for securing rear door 120 in a closed configuration with body 110. Pivot flanges 134 may attach to supporting tubing 122 of rear door 120. Tube 136 may extend between and be pivotally attached to pivot flanges 134, and latch flange 138 connected to tubing 119 and held in place by retaining pin 132. An aperture (not shown) may extend through latch flange 138 and tubing 119 of side wall 112. Thus, retaining pin 132 may lock the rear door locking device 130 by being placed in the aperture. Retaining pin 132 may be further held in place by a safety latch 139, reducing the possibility of retaining pin 132 releasing undesirably.

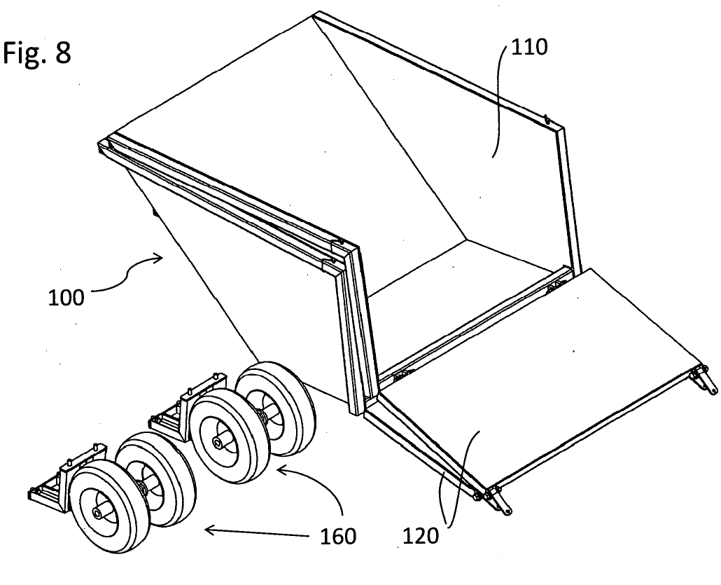

FIG. 8 illustrates dumping tubs 100 prepared for transport in a compact position. Tub bodies 110 may have sloped sidewalls 112 and sloping front wall 116. Rear door 120 may be opened, in a stacked configuration. Wheel assemblies 160 may be transported inside stacked tub bodies 110 and attached to the tub bodies 110 after transportation. This reduces transportation cost because of the reduced space requirements.

FIG. 9 illustrates wheel assembly 160 attaching to the tub body 110. Wheel assembly 160 may connect to tub body 110 with mounting bracket 164 that attaches to tub body 110 through bracket attachment points 166. Mounting bracket 164 may remain stationary, while allowing wheel 168 to pivot, such as with caster wheels.

Wheel assembly 160 may be easily and removably attached to tub body 110 via bracket attachment points 166. Bracket attachment points 166 may include bolts or screws or other attachment devices that are easily removable. Once removed, tub body 110 may be stacked with other tub bodies as seen in FIG. 7, with wheel assembly 160 placed in tub body 110. Thus, an easily removable and attachable wheel assembly 160 provides for economical transportation.

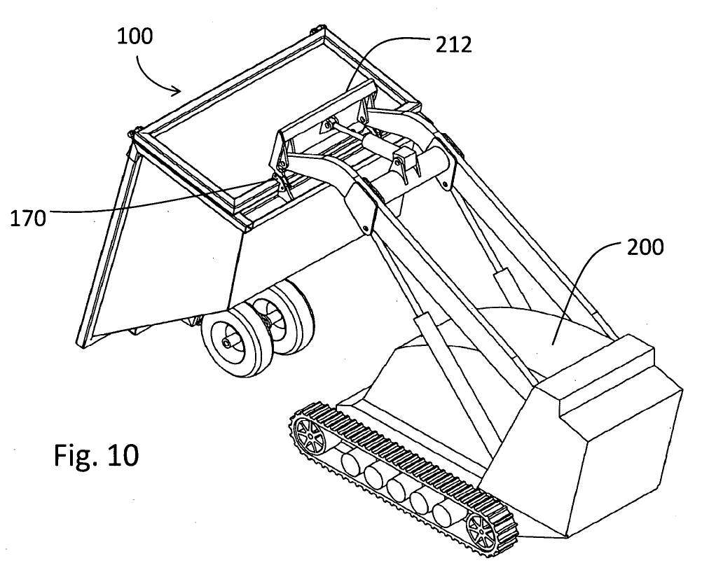

FIG. 10 illustrates another embodiment wherein utility loader 200 may attach to dumping tub 110 via bucket connector 212. The bucket (not shown) may be removed from utility loader 200 by releasing it from bucket connector 212. Bucket connector 212 may be pivotly attached to dumping tub 100 by bucketless mounting structure 170. Dumping tub 100 may pivot with respect to bucketless mounting structure 170, and may be attached near the bottom of dumping tub 100. The placement of mounting structure 170 near the bottom of dumping tub 100 may allow utility loader 200 to fully rotate dumping tub 100 upright, when compared with a similar attachment at the top, similar to mounting structure 140.

The attachment of utility loader 200 directly to dumping tub 100 may provide further advantages. For example, the length of the lever arm between utilty loader 200 and dumping tub 100 may be reduced, thus reducing the strain on utility loader boom 220. An operator may be no longer required to balance the angle of the bucket (not shown) with the dumping tub 100, reducing the complexity of the task.

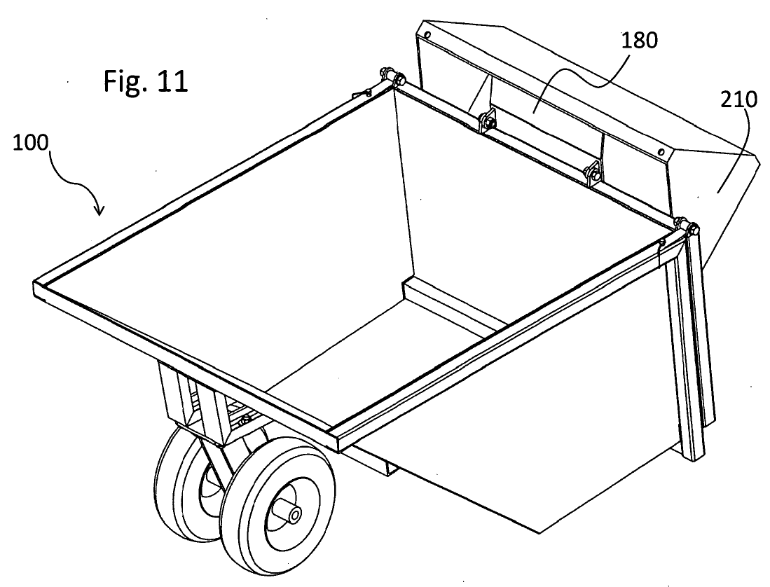

FIG. 11 illustrates bucket hanger 180 on dumping tub 100. Bucket hanger 100 may allow an operator to take bucket 210 with utility loader 200 and dumping tub 100 wherever they may go. When the desired work spot is found, dumping tub 100 may be released and bucket 210 immediately reattached. This may save a user from returning for bucket 210 at another location.

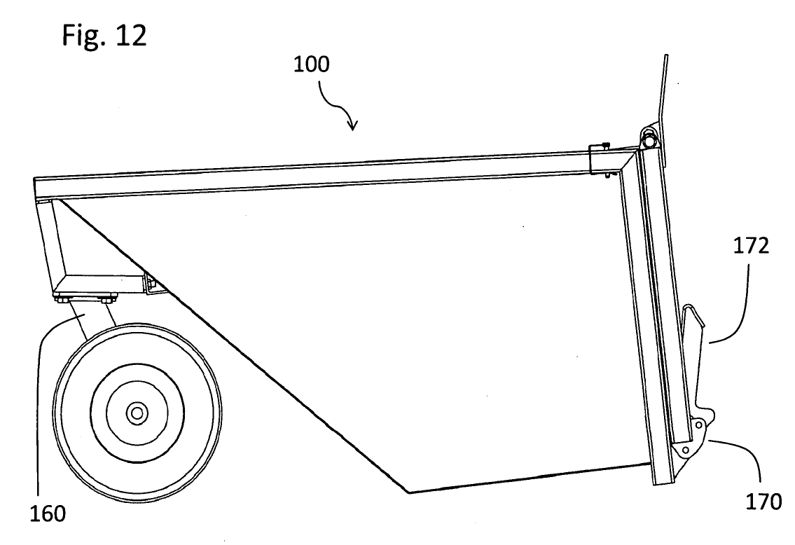

FIG. 12 illustrates bucketless mounting structure 170. Bucketless mounting structure 170 may include mounting arms 172 that connect with a bucket connector (not shown) of utility loader 200. Mounting arms 172 may be pivotly attached near the bottom of dumping tub 100, such that dumping tub 100 may be easily raised to the dumping position.

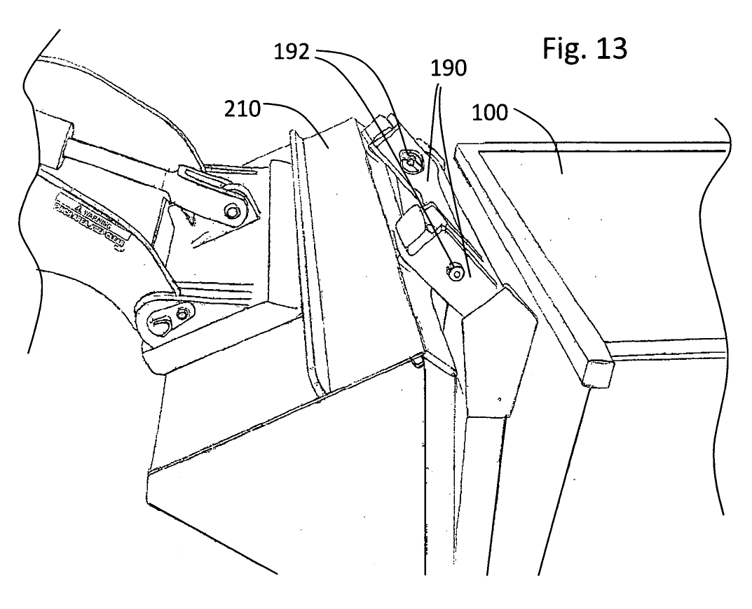

FIG. 13 illustrates another embodiment where bucket 210 attaches to attachment lever 190 that is pivotly attached near the bottom of dumping tub 100. Attachment lever 190 may be attached to bucket 210 via bucket posts (not shown) held in place by pins 192. This connection may allow for a secure connection to buckets 210 with the bucket posts (not shown) where dumping tub 100 may contain material too heavy for other embodiments. Further, the connection may be made at a height that is more visible to the upright person, allowing for an improved view of the connection as it is being made. The attachment of attachment lever 190 near the bottom of dumping tub 100 may retain the advantage of a lesser utility loader boom 220 height required to place dumping tub 100 in a dumping position. Similarly, bucket 210 may be rotated to achieve additional dumping height.

In some embodiments, utility loader 200 may engage with dumping tub 100 in various ways while maintaining a pivot point at or near the bottom of dumping tub 100 to allow for the advantages described above.

The present invention may be embodied in other specific forms without departing from its essential characteristics. The described embodiments are to be considered in all respects only as illustrative, and not restrictive. The scope of the invention is, therefore, indicated by the appended claims, rather than by the foregoing description. All changes within the meaning and range of equivalency of the claims are to be and braced within their scope.

What is claimed is:

1. A dumping tub, comprising:
a tub body; and
an attachment structure including a pivot connection to the tub body located at or near a bottom edge of the tub body, wherein the attachment structure is configured to engage with a lifting device, wherein the mounting structure is configured to provide a freely pivoting joint between the tub body and the lifting device.

2. The dumping tub of claim 1, wherein the pivot connection is a hinge.

3. The dumping tub of claim 2, wherein the hinge includes at least one slotted flange configured to engage an edge of the bucket.

4. The dumping tub of claim 1, wherein the mounting structure is configured to releasably attach to a bucket connector of the lifting device.

5. The dumping tub of claim 4, further comprising a bucket hanger configured to releasably attach a bucket to the dumping tub, the bucket being configured to be attached to the lifting device.

6. The dumping tub of claim 1, wherein the attachment structure is configured to releasably attach to a bucket on the lifting device and transfer movement of the bucket to the tub body.

7. The dumping tub of claim 6, wherein the mounting structure includes a plurality of arms configured extend away from the tub body about the pivot connection.

8. The dumping tub of claim 1, wherein the dumping tub further comprises at least one wheel assembly.

9. The dumping tub of claim 8, wherein the at least one wheel assembly is configured to stay in contact with the ground until the dumping tub is rotated past a point where both a front wall of the dumping tub and the wheel assembly contact the ground simultaneously.

10. The dumping tub of claim 8, wherein the at least one wheel assembly is a twin-wheel caster assembly.

11. The dumping tub of claim 1, wherein the tub body includes a rear door.

12. The dumping tub of claim 12, wherein the rear door is configured to open such that the rear door is usable as a ramp for entry into the dumping tub.

13. The dumping tub of claim 1, wherein the mounting structure is configured to engage with a portion of a lifting device selected from the group of backhoe, loader, atv, yard tractor, farm tractor, utility loader, skid-steer loader, excavator, dump truck, crawler-tractor, wheel loader, and forklift.

14. A dumping tub, comprising:
a tub body configured to have one end raised and lowered by a separate machine;
a plurality of mounting structures pivotably connected to the tub body and configured to engage with the machine, wherein the mounting structure is configured to provide a freely pivoting joint between the tub body and the machine while engaged; and
a rear door pivotly connected to a tub body and configured to:
retain material in the tub body when closed;
expose an entrance to the tub body such that a the machine may enter the tub body when open.

15. The dumping tub of claim 14, further comprising a plurality of flared side walls, wherein the flared side walls are configured to allow the dumping tub to stack with other dumping tubs.

16. The dumping tub of claim 15, further comprising a plurality of wheel assemblies configured to be removably attached to the dumping tub.

17. The dumping tub of claim 14, further comprising a rear door locking mechanism configured to selectively lock the rear door to the tub body, wherein the rear door locking mechanism includes,
a plurality of attachment flanges,
an arm pivotly attached to the attachment flanges, and
a locking pin configured to engage the arm and complete the connection between the rear door and tub body.

18. A method of transporting a dumping tub, comprising:
engaging the dumping tub to a machine through a freely pivotable mounting structure, wherein the freely pivotable mounting structure pivots about a substantially horizontal axis at or near a bottom edge of the dumping tub;
causing the machine to lift one end of the dumping tub such that a wheel assembly of the dumping tub is in contact with the ground;
causing the machine to transport the dumping tub to a new location;
causing the machine to lower the one end of the dumping tub; and
disengaging the dumping tub from the machine at the new location.

19. The method of claim 18, further comprising the step of attaching a bucket to the dumping tub, wherein the bucket is configured to be removably attached to the machine.

20. The method of claim 18, further comprising the steps of
opening a rear door on the dumping tub, and
causing the machine to enter the tub body.
